(19) United States
(12) Patent Application Publication
(10) Pub. No.: US 2007/0268324 A1
(43) Pub. Date: Nov. 22, 2007

(54) Method and apparatus for calculating natural frequency of an ink-jet head

(75) Inventors: Won-Chul Sim, Seongnam-si (KR); Jae-Woo Joung, Suwon-si (KR); Chang-Sung Park, Suwon-si (KR); Sung-Jun Park, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/797,887

(22) Filed: May 8, 2007

(30) Foreign Application Priority Data
May 8, 2006 (KR) 10-2006-0041147

(51) Int. Cl. B41J 29/393

(52) U.S. Cl. 347/19

(57) ABSTRACT

A method and apparatus for calculating the natural frequency of an ink-jet head are disclosed. With a method of determining a natural frequency of an ink-jet head operated by a piezoelectric actuator by joining a sensor to the piezoelectric actuator, which includes supplying electrical power to the piezoelectric actuator; receiving data on the vibration of the ink-jet head as input from the sensor and storing the data; transforming the data and outputting a vibration waveform of the ink-jet head; and analyzing the vibration waveform and to determine the natural frequency of the ink-jet head ink-jet head, the natural frequency of the ink-jet head of high reliability may be determined. In addition, the time required for detecting natural frequency may be reduced.

### CROSS-REFERENCE TO RELATED APPLICATIONS

This application claims the benefit of Korean Patent Application No. 10-2006-0041147 filed with the Korean Intellectual Property Office on May 8. 2006, the disclosure of which is incorporated herein by reference in its entirety.

### BACKGROUND

1. Technical Field

The present invention relates to method and apparatus for calculating the natural frequency of an ink-jet head.

2. Description of the Related Art

When an ink-jet head having a piezoelectric actuator discharges an ink, the ink-jet head may effectively suppress the vibration of menisci and discharge the ink stably by synchronizing the discharging time, which is of a drive waveform, and the holding time after discharging, with the natural frequency of the pressure chamber. For determining the natural frequency of the pressure chamber, the method of directly measuring the menisci has been used.

FIG. 1 is a schematic diagram showing an apparatus and method for determining the natural frequency of the pressure chamber of an ink-jet head according to prior art.

Referring to FIG. 1, the input waveform, which is like a sine wave, is provided to a piezoelectric actuator, and a light synchronized with the input is emitted using an LED. Then, the nozzle is observed by stroboscopy.

Here, the magnitude of the vibration of the menisci according to the above is observed while changing the frequency of the applied input waveform. The natural frequency (fc) of the pressure chamber is the frequency at which the magnitude is the greatest.

This mode entails the problem that it is difficult to quantitatively determine the frequency in which the vibration of the menisci is the greatest from a photo image obtained with the stroboscope. Also, it takes a long time to determine the frequency because users have to experiment with different frequencies.

### SUMMARY

An aspect of the present invention is to provide a method and an apparatus for calculating the natural frequency of an ink-jet head which can reduce the calculating time and offer high reliability, by picking up a vibration directly from the membrane of the ink-jet head to calculate the natural frequency of the pressure chamber.

One aspect of the invention provides a method of determining the natural frequency of an ink-jet head operated by a piezoelectric actuator by joining a sensor to the piezoelectric actuator, which includes supplying electrical power to the piezoelectric actuator, receiving data on the vibration of the ink-jet head as input from the sensor and storing the data, transforming the data and outputting a vibration waveform of the ink-jet head; and analyzing the vibration waveform to calculate the natural frequency of the ink-jet head.

The method of determining the natural frequency of an ink-jet head according to embodiments of the invention may include one or more of the following features. For example, the sensor may be an LDV (Laser Doppler Vibrometer) and the data may be voltage with respect to time.

Also, the transforming may be performed by a FFT (Fast Fourier Transform) analysis module and the vibration waveform may be outputted as amplitude with respect to frequency.

Meanwhile, another aspect of the invention provides an apparatus for calculating the natural frequency of an ink-jet head for discharging ink held in a pressure chamber through a nozzle connected to the pressure chamber by operating the piezoelectric actuator joined to a membrane to apply pressure to the pressure chamber. The apparatus includes a sensor connected to the piezoelectric actuator, a storing part for receiving and storing data from the sensor, a processing part for transforming the data to be in correspondence with the vibration waveform of the ink-jet head, and an output part for outputting the data transformed by the processing part.

The apparatus for calculating the natural frequency of an ink-jet head according to embodiments of the invention may include one or more of the following features. For example, the sensor may be an LDV (Laser Doppler Vibrometer) and the data may be voltage with respect to time.

Also, the processing part may include a FFT (Fast Fourier Transform) analysis module and an output of the output part may be in the form of amplitude with respect to frequency.

Additional aspects and advantages of the present invention will become apparent and more readily appreciated from the following description, including the appended drawings and claims, or may be learned by practice of the invention.

### BRIEF DESCRIPTION OF THE DRAWINGS

FIG. 1 is a schematic diagram showing a method for determining the natural frequency of the ink-jet head according to prior art.

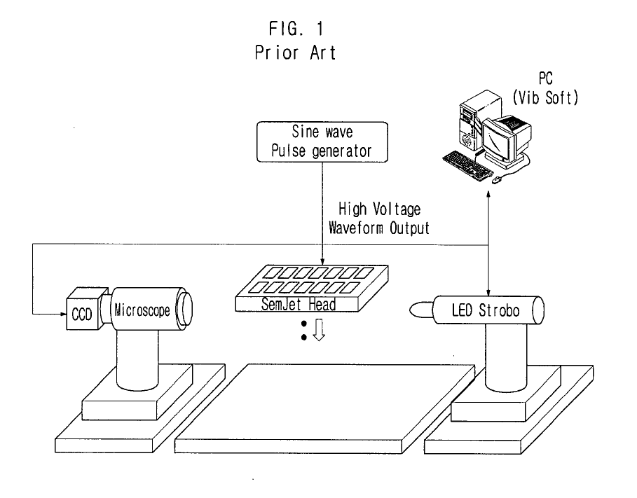

FIG. 2 is a flowchart showing a method for calculating the natural frequency of the ink-jet head according to an embodiment of the present invention.

FIG. 3 is a block diagram showing an apparatus for calculating the natural frequency of the ink-jet head according to an embodiment of the present invention.

FIG. 4 is a graph showing displacement data with respect to the frequency of the vibration waveform outputted for data inputted according to an embodiment of the present invention.

FIG. 5 is a graph showing displacement data with respect to the frequency of the vibration waveform outputted in the case of applying the natural frequency calculated according to an embodiment of the present invention to the input waveform.

### DETAILED DESCRIPTION

Embodiments of the method and apparatus of determining the natural frequency of ink jet head according to the invention will be described below in more detail with reference to the accompanying drawings. In the description with reference to the accompanying drawings, those components are rendered the same reference number that are the same or are in correspondence, regardless of the figure number, and redundant explanations are omitted.

Firstly, an apparatus for calculating the natural frequency of the ink-jet head according to an embodiment of the present invention is described below.

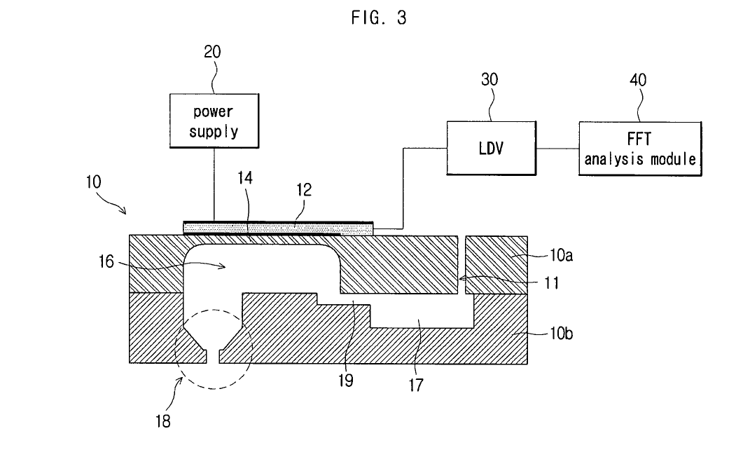

FIG. 3 is a block diagram showing the apparatus for calculating the natural frequency of the ink-jet head according to an embodiment of the present invention. Referring to FIG. 3, an ink-jet head 10, a flow channel 11, a piezoelectric actuator 12, a membrane 14, a pressure chamber 16, a reservoir 17, a nozzle 18, a restrictor 19, an electrical power part 20, a Laser Doppler Vibrometer (LDV) 30 and a Fast Fourier Transform (FFT) analysis module 40 are illustrated.

An apparatus for determining the natural frequency of the ink-jet head according to one aspect of the present invention may comprise an ink-jet head including a membrane 14 and a piezoelectric actuator 12 formed on one side of the membrane 14, an electrical power part 20 for supplying electrical power to the piezoelectric actuator 12, a LDV 30 connected to the piezoelectric actuator for detecting the vibration of the piezoelectric actuator, a storing part (not shown) for storing vibration data detected by the LDV 30 and a FFT analysis module 40 for transforming the data stored in the storing part by a FFT (Fast Fourier Transform) to correspond to the vibration waveform of the ink-jet head.

The apparatus for determining the natural frequency of the ink-jet head according to one aspect of the present invention may reduce the determining time and offer high reliability by detecting the vibration of the piezoelectric actuator 12 or membrane 14 to calculate the natural frequency.

The apparatus according to an aspect of the invention may reduce the calculating time and offer high reliability by directly detecting the vibration of the piezoelectric actuator or the membrane, and determining the natural frequency.

The ink-jet head 10 according to this embodiment of the invention may have the basic configuration of a lower plate 10b and an upper plate 10a, with the upper plate 10a welded onto the top of the lower plate 10b, and a piezoelectric actuator 12 may be joined with the upper plate 10a.

In the lower plate 10b, a reservoir 17, a restrictor 19, a nozzle 18 etc. may be formed by etching or laser etching. The reservoir 17 for holding the ink that flows in from a flow channel 11 may be formed at one side of the lower plate 10b, and the nozzle 18 for discharging the ink for printing may be formed at the other side of the lower plate 10b.

Meanwhile, the restrictor 19 for connecting the reservoir 17 to the pressure chamber 16 and for controlling the amount of ink delivered from the reservoir 17 to the pressure chamber 16 may be formed adjacent to the reservoir 17.

The reservoir 17 may be formed at one side of the lower plate 10b. The reservoir 17 may be provided with the ink through the flow channel 11 and the reservoir 17 may provide the ink to the pressure chamber 16 through the restrictor 19.

The restrictor 19 may be connected with the reservoir 17 and the pressure chamber 16. The restrictor 19 may be formed with a cross-sectional area smaller than that of the reservoir 17. Also, the restrictor 19 may control the amount of ink supplied from the reservoir 17 to the pressure chamber 16 when the upper plate 10a is made to vibrate by the piezoelectric actuator 12.

The nozzle 18 may be connected with the pressure chamber 16. The ink supplied from the reservoir 17 to the pressure chamber 16 may be provided to the nozzle 18 by the vibration of the upper plate 10a generated by the piezoelectric actuator 12. Then, the ink may be discharged through the nozzle 18, and printing may take place.

In the upper plate 10a, a flow channel 11, a pressure chamber 16, and a membrane 14 may be formed by etching or laser etching. The flow channel 11 for supplying the ink to the reservoir 17 may be formed in a portion of the upper plate 10a corresponding to the reservoir 17 formed in the lower plate 10b. The pressure chamber 16 may be formed in a portion of the upper plate 10a corresponding to the nozzle 18 formed in the lower plate 10b. Also, the membrane 14 may be formed in the upper part of the pressure chamber 16, where the membrane 14 may be joined with the piezoelectric actuator 12 to receive the vibration from the piezoelectric actuator 12.

The pressure chamber 16 may be formed in a portion of the upper plate 10a corresponding to the nozzle 18 formed in the lower plate 10b and may be connected with the reservoir 17 through the restrictor 19. Moreover, the portion of the pressure chamber 16 which is not connected with the restrictor 19 may be connected with the nozzle 18. Therefore, the pressure chamber 16 may receive the ink from the reservoir 17 and supply the ink to the nozzle 18, whereby printing may take place.

The membrane 14 may be formed on the upper portion of the pressure chamber 16, where the part remaining after removing a part of the upper plate 10a may be formed to become the membrane 14.

The piezoelectric actuator 12 may be formed on the upper portion of the membrane 14. When a vibration is generated by the piezoelectric actuator 12, the membrane 14 may vibrate together. In this way, the upper plate 10a may be made to vibrate.

The piezoelectric actuator 12 may be formed on the upper side of the membrane 14, and the piezoelectric actuator may supply the driving force to the ink-jet head by receiving electrical power from the power supply 20 and supplying a vibration to the membrane 14. The vibration of the piezoelectric actuator for determining the natural frequency of the ink-jet head may be detected by the LDV 30, as is described later on.

In this way, the upper plate 10a and the lower plate 10b having the various structures within may be put together to manufacture an ink-jet head.

Meanwhile, the present invention relates to an apparatus for determining the natural frequency of the pressure chamber of the ink-jet head, and the ink-jet head is merely for describing an embodiment shown in FIG. 3. Thus, it is apparent that the apparatus may be applied to various other kinds of ink-jet head besides the ink-jet head described above.

The power supply 20 may be connected with the piezoelectric actuator 12, and the power supply 20 may supply electrical power to the piezoelectric actuator 12 to allow the piezoelectric actuator 12 to generate vibration and deliver the vibration to the membrane 14.

The LDV 30 may detect the vibration of the piezoelectric actuator 12, and the LDV 30 may analyze a detected vibration and process it. Then, the LDV 30 may convert it to a signal, and provide the signal in the form of a voltage or electric current.

Meanwhile, referring to the embodiment in FIG. 3, it is formed so that the LDV 30 detects the vibration of the piezoelectric actuator 12, not that of the membrane 14.

However, the piezoelectric actuator 12 and membrane 14 are joined with each other to efficiently deliver the vibration. For this reason, the vibration of the piezoelectric actuator 12 and membrane 14 may have the same frequency, and thus, in the embodiment shown in FIG. 3, the LDV 30 is formed to detect the vibration of the piezoelectric actuator 12 for effective detection. It is apparent, however, that the LDV 30 may be formed to detect the vibration of the membrane 14 directly.

Vibration data detected by the LDV 30 may be inputted to a storing part (not shown) and stored in the storing part. While the LDV 30 is presented as the means for detecting vibration in the embodiment of FIG. 3, it is apparent that the LDV 30 may be substituted by various known vibration detecting means according to design requirements, etc.

The storing part (not shown) may receive the vibration data detected by the LDV 30 and store the data. The storing part (not shown) may provide the stored data to the FFT analysis module 40.

The FFT analysis module 40 may be connected with the storing part and transform the data stored in the storing part according to the vibration waveform of the ink-jet head. The transformed data may be provided in the form of ASCII data or a graph, which may be performed by an output part (not shown).

While in this embodiment, the FFT analysis module 40 is presented as a signal transforming device, it is apparent that the FFT analysis module 40 may be substituted by various known signal transforming devices according to design requirements, etc.

The output part (not shown) may be connected with the FFT analysis module 40 and may provide the data transformed by the FFT analysis module 40 in the form of ASCII data or a graph. Meanwhile, the output part may output the data transformed by the FFT analysis module 40 as amplitude with respect to a frequency. A user may determine the natural frequency of the ink-jet head by analyzing the data outputted as amplitude with respect to frequency.

A description will now be given below on the operation of the apparatus for calculating the natural frequency of the ink-jet head according to one aspect of the present invention.

When the electrical power is applied to the piezoelectric actuator 12 by the power supply, the piezoelectric actuator 12 may generate a vibration. The vibration generated by the piezoelectric actuator 12 may be delivered to the membrane 14 joined with the piezoelectric actuator 12, and the ink-jet head may discharge the ink due to the vibration of the membrane 14 through the nozzle 18. In this way, printing may take place.

Meanwhile, when the membrane 14 is made to vibrate by the vibration of the piezoelectric actuator 12, the LDV 30 may detect the vibration of the piezoelectric actuator 12 or the vibration of the membrane 14. Then, the detected data may be inputted to the storing part (not shown) and stored in the storing part.

The data stored in the storing part (not shown) is transformed to correspond to the vibration waveform of the ink-jet head by the FFT analysis module 40, and the data transformed by the FFT analysis module 40 may be provided in the form of ASCII data or a graph by the output part. Here, the output part may output the value of the amplitude of the vibration with respect to frequency, and a user may determine the natural frequency of the ink-jet head by analyzing the outputted value.

Next, a description will be given on a method for calculating the natural frequency of the ink-jet head according to an embodiment of the present invention.

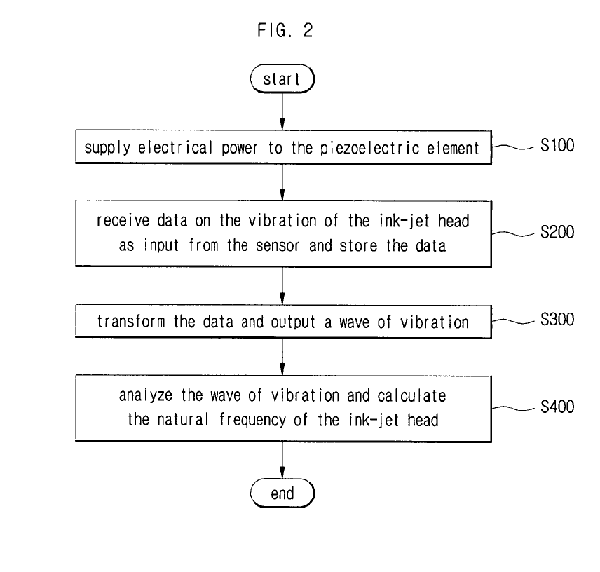

FIG. 2 is a flowchart showing the method for determining the natural frequency of the ink-jet head according to an embodiment of the present invention. Referring to FIG. 2, the method may include supplying electrical power to the piezoelectric actuator S100, receiving data on the vibration of the ink-jet head as input from the sensor and storing the data S200, transforming the data and outputting a vibration waveform S300, and analyzing the vibration waveform and determining the natural frequency of the ink-jet head S400.

A method for determining the natural frequency of the ink-jet head according to an embodiment of the present invention may reduce the determining time and offer high reliability by detecting the vibration of the piezoelectric actuator 12 or the membrane 14 directly.

The supplying of electrical power S100 may be performed by the power supply 20. When the electrical power is supplied, the piezoelectric actuator 12 may generate a vibration and deliver it to the membrane 14 of the ink-jet head.

The detecting of vibration of the piezoelectric actuator and storing of data S200 may be an operation of detecting the vibration of the piezoelectric actuator 12 by means of a sensor and storing the resulting data. The LDV 30 may be used as a sensor. The vibration of the piezoelectric actuator 12 may be detected by the LDV 30, and the detected vibration data may be stored in the storing part (not shown) in the form of voltage with respect to time. The stored data may be transformed and outputted. While in the present embodiment the LDV 30 is presented as a sensor, it may readily be changed according to design requirements, etc.

The transforming of data and outputting of a vibration waveform S300 may be an operation of transforming the data stored as described above to a vibration waveform and outputting the transformed data. The transforming may be performed by the FFT (Fast Fourier Transform) analysis module 40 and the vibration waveform may have a value of amplitude with respect to frequency. The outputted wave may be provided in the form of ASCII data or a graph. The outputted vibration waveform may be used as the data for detecting the natural frequency of the ink-jet head.

The analyzing of the vibration waveform and determining of the natural frequency S400 may be an operation of analyzing the vibration waveform outputted as described above to determine the natural frequency of the ink-jet head. The natural frequency may be detected and calculated by analyzing the outputted vibration waveform and detecting the frequency where the peak is generated.

In this way, the present embodiment of the invention may offer a natural frequency of high reliability and save time in detecting the natural frequency.

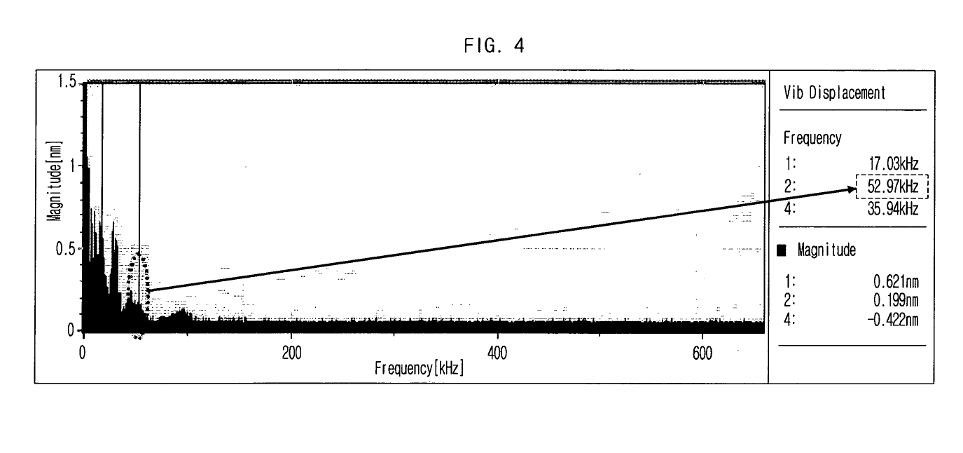

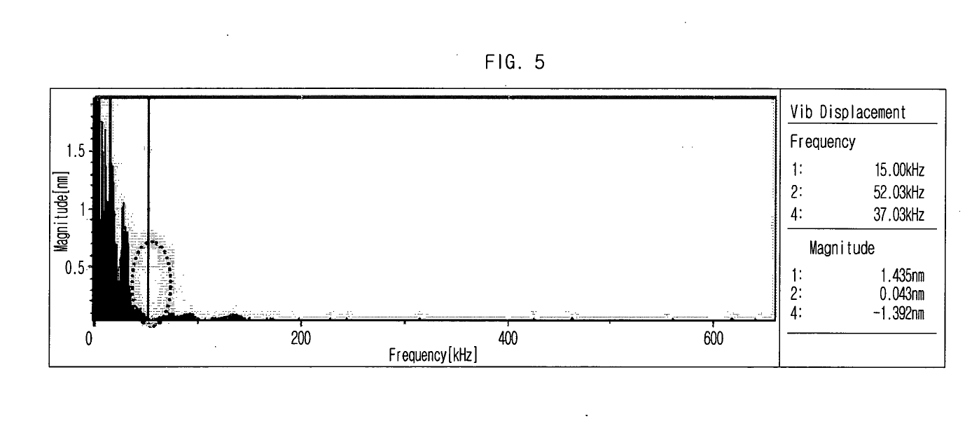

Referring to FIGS. 4 and 5, the reliability of the natural frequency detected by the present embodiment of the invention and the improvement in discharging of the ink-jet head will be described below. The dimensions of the ink-jet head used in the embodiment are as follows.

| | Dimensions [um] |
|---|---|
| Nozzle Diameter | 30 |
| Nozzle Length | 100 |
| Restrictor Length | 3000 |
| Restrictor Depth | 130 |
| Restrictor Width | 150 |
| Pressure Chamber Depth | 350 |
| Pressure Chamber Length | 4000 |
| Pressure Chamber Width | 600 |

FIG. 4 is a graph showing displacement data with respect to frequency of the vibration waveform outputted for data inputted based on an embodiment of the present invention. FIG. 4 illustrates the frequency characteristics of the pressure chamber having the above dimensions which are detected by the method and apparatus according to an embodiment of the invention. The peak may be observed at 53 kHz. This frequency (53 kHz) may be regarded as the natural frequency.

Meanwhile, the natural frequency (fc) may be described by the following equation:

$${f}_{c } = \frac{1}{2 π} \sqrt{\frac{{M}_{n} + {M}_{s}}{{M}_{n} \cdot {M}_{s} \cdot {C}_{c}}}$$

Here, Mn is the inertance of the nozzle, and Ms is the inertance of the ink supply portion. Cc is the compliance of the pressure chamber. The compliance of the pressure chamber may be expressed as ‘the volume of the pressure chamber/the sonic velocity of the ink’.

The natural frequency of the pressure chamber used in the present embodiment calculated using the equation is 52.3 kHz. This is almost identical to the frequency observed in FIG. 4. From this, it is seen that the frequency determined by the method and apparatus according to an embodiment of the present invention have high reliability.

FIG. 5 is a graph showing displacement data with respect to frequency for the vibration waveform outputted in the case of applying to the input waveform the natural frequency determined according to an embodiment of the present invention. Referring to FIG. 5, it is seen that the peak at 53kHz of FIG. 4 has disappeared. This is because the vibration of the meniscus was effectively attenuated by synchronizing the natural frequency of the meniscus and the frequency of the input waveform. In this way, the discharging may be performed in a stable manner by suppressing the residual vibration of the meniscus in the high-frequency wave discharge.

Because an ink-jet head may have many nozzles, for example 128 or 256 nozzles, the natural frequency of each pressure chamber may be different from one another. Thus, the discharging may be performed in a stable manner by controlling each head individually, in which the controlling may be performed by detecting the natural frequency of each nozzle with the method and the apparatus according to embodiments of the present invention and by applying it to the drive waveform.

As described in the above, according to certain embodiments of the present invention, the natural frequency of the ink-jet head may be determined with high reliability. In addition, the time required for determining the natural frequency may be reduced.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A method of determining the natural frequency of an ink-jet head operated by a piezoelectric actuator by joining a sensor to the piezoelectric actuator, the method comprising:
supplying electrical power to the piezoelectric actuator;
receiving data on a vibration of the ink-jet head as input from the sensor and storing the data;
transforming the data and outputting a vibration waveform of the ink-jet head; and
analyzing the vibration waveform and determining the natural frequency of the ink-jet head.

2. The method of claim 1, wherein the sensor is an LDV (Laser Doppler Vibrometer) and the data is voltage with respect to time.

3. The method of claim 1, wherein the transforming is performed by a FFT (Fast Fourier Transform) analysis module and the vibration waveform is outputted as amplitude with respect to frequency.

4. An apparatus for determining a natural frequency of an ink-jet head for discharging ink held in a pressure chamber through a nozzle connected to the pressure chamber by operating the piezoelectric actuator joined to a membrane to apply pressure to the pressure chamber, the apparatus comprising:
a sensor connected to the piezoelectric actuator;
a storing part for receiving and storing data from the sensor;
an processing part for transforming the data to be in correspondence with the vibration waveform of the ink-jet head; and
an output part for outputting the data transformed by the processing part.

5. The apparatus claim 4, wherein the sensor is an LDV (Laser Doppler Vibrometer) and the data is voltage with respect to time.

6. The apparatus of claim 4, wherein the processing part comprises a FFT (Fast Fourier Transform) analysis module and an output of the output part is in a form of amplitude with respect to frequency.
